(19) United States
(12) Patent Application Publication
(10) Pub. No.: US 2013/0124308 A1
(43) Pub. Date: May 16, 2013

(54) BUDGET-BASED ADVERTISMENT BIDDING

(71) Applicants: John Hegeman, Palo Alto, CA (US); Rong Yan, Montain View, CA (US); Gregory Joseph Badros, (US)

(72) Inventors: John Hegeman, Palo Alto, CA (US); Rong Yan, Montain View, CA (US); Gregory Joseph Badros, (US)

(21) Appl. No.: 13/294,094

(22) Filed: Nov. 10, 2011

(51) Int. Cl. G06Q 30/02

(52) U.S. Cl. 705/14.48

(57) ABSTRACT

An online advertising system receives ads from advertisers, which may also provide associated budgets, time period constraints, impressions goals, and performance weightings for the ads. When an ad is requesting from the advertising system from a client, a bid may be determined for each ad based on the budget associated the ad and/or the impressions goal associated with the ad. Ad performance associated with the ad request may be predicted, and a bid may be determined for each ad based on the performance weightings and the predicted performance associated with the ad request. The bid for an ad may be weighted by the pace of budget consumption by the ad, or by the pace of the ad progressing towards the ad's impression goal. An ad is selected for display to the client from among the one or more ads based on the determined bids for the ads.

### CROSS-REFERENCE TO RELATED APPLICATION

This application is related to U.S. patent application Ser. No. 13/294,052, titled “Multi-dimensional advertisement bidding,” filed on Nov. 10, 2011, which is incorporated by reference herein in its entirety.

### BACKGROUND

This invention relates to optimizing advertisement bidding, and more particularly to determining advertisement bids for advertisers based on an advertising budget and/or weighted performance categories provided by the advertisers.

Online services, such as social networking systems, search engines, news aggregators, Internet shopping services, and content delivery services, have become a popular venue for presenting advertisements to prospective buyers. Some online services provide their services free of charge or charge only minimal fees. Instead, the online services generate revenue by presenting advertisements (“ads”) to users, who may take certain actions based on the presented ads (e.g., clicking of the ads). The ad-based online service model has spawned many diverse types of online services.

Online services often use a scheme that charges ad fees commensurate with the number of times the ads are displayed to the users or actions taken by the users in response to viewing the ads. The pricing structure widely used in online services for assessing ad fees includes, for example, Cost Per Impression (CPI) and Cost Per Action (CPA). The CPI-based pricing structure assesses ad fees based on the number of instances an ad is loaded and displayed on a user's screen, typically in response to a user's request for a content item. The CPA-based pricing structure assesses ad fees based on actions taken by the users after the ads are displayed on the screen. The actions taken into account for the CPA-based pricing structure may include, among others, the following: (i) clicking on the ad, (ii) registration to the advertiser's service or product and (iii) conclusion of a sale of a service or product. Rather than using CPI or CPA-based pricing structure, some online services charge a flat fee for displaying an ad for a certain amount of time.

Some online services adopt a bidding system that allows multiple advertisers to manually bid for ad space. When an ad is required for a particular ad space, the ad with the highest bidding price is selected and presented in the ad space to maximize the ad fees. The bidding price may be based on CPI, CPA, or other expected revenue values. The bidding system may also employ a cap for limiting the amount of ad fees for a set period of time (e.g., day or month). Manually bidding for an ad is a tedious process, requiring multiple advertisers to track current winning bids for ads, to update bids for ads as needed, and the like. The context of an ad may affect the value of the ad to an advertiser, and accordingly, may affect the amount the advertiser is willing to bid for the ad. The display of an ad to a viewer of the ad is referred to herein as an ad “impression.”

### SUMMARY

Embodiments of the invention determine advertisement bids for one or more ads in response to receiving a request for an ad from a client. A plurality of advertisers provides ads, ad budgets, and ad impressions goals. A bid is determined for one or more of the ads based on a budget associated with the ad and an impressions goal associated with the ad. An ad is selected from among the one or more ads based on the determined bids. For instance, the ad associated with the highest bid may be selected, or the ad associated with the highest expected value (the bid for the ad multiplied by the probability of a click) may be selected. The selected ad is then provided to the client for display.

The historical statistics of ads may be tracked, including the total amount spent on displaying the ads and the total number of impressions for a given period in time. The bid may further be determined based on the remaining budget for the ad, the number of impressions for the ad required to reach the impressions goal for the ad, and the remaining time that an ad is eligible to be displayed, based on the tracked historical statistics of the ad.

The bid may also be based on a combination of an impression value and a pacing value. The impression value of the ad may be determined based on the potential value of an impression of the ad at the requesting client to an advertiser associated with the ad. Likewise, the pacing value of the ad may be determined based on the value of displaying the ad in view of the pace of the impressions of the ad. Before determining a bid for the ad, the impression value and the pacing value may be weighted based on the remaining budget for the ad, the remaining impressions required for the ad to reach the ad's impressions goal, and the remaining time for which the ad is eligible to be displayed.

### BRIEF DESCRIPTION OF THE DRAWINGS

FIG. 1 is a block diagram illustrating the operation of automated bidding in an advertisement system, according to one embodiment.

FIG. 2 is a high level block diagram of a system environment suitable for performing budget-based bidding or bidding based on multiple goals and constraints, according to one embodiment.

FIG. 3 is a block diagram illustrating an ad database configured to receiving ads, ad constraints and ad context goals from one or more advertisers, according to one embodiment.

FIG. 4 is a block diagram illustrating a bidding module configured to receive information related to the ad and to produce a bid for the ad, according to one embodiment.

FIG. 5 is a flowchart illustrating a process for selecting an ad for display based on the ad's budget and advertiser goals, according to one embodiment.

FIG. 6 is a flowchart illustrating a process for selecting an ad for display based on ad performance weightings, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

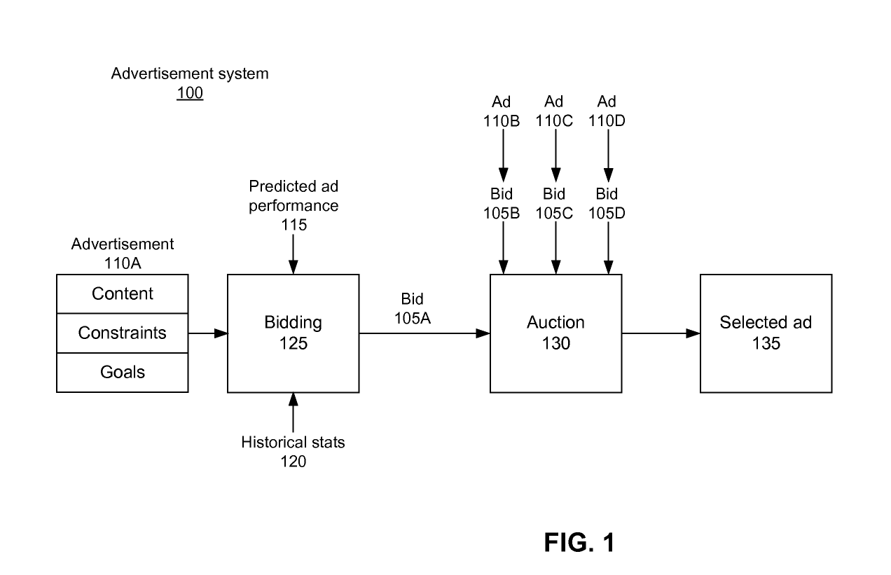

FIG. 1 is a block diagram illustrating the operation of automated bidding in an advertisement system, according to one embodiment. In one embodiment, the advertisement system 100 receives a request for an ad, for instance from a client. The ad system 100 determines a plurality of bids 105A-105D (“105”) for a plurality of ads 110A-110D (“110”). Although only four bids 105 are shown in FIG. 1, other embodiments include any number of bids 105, for instance thousands. Bids 105 may be determined for each of a plurality of ads, or for a subset of the plurality. Each bid 105 is associated with a particular ad 110. The bids are sent to an auction module 130 which selects an ad as the selected ad 135 based on the received bids. The selected ad 135 is then sent to the client for display.

Each ad 110 for which a bid 105 is determined includes ad content, and may include ad constraints and ad goals. As will be discussed below, the ad 110 is provided by an advertiser, which provides the ad content and sets the ad's constraints and goals. Ad constraints include the ad's budget, the time period for which the ad will be displayed, and any other constraints affecting the display of the ad 110. Ad goals include the number of impressions desired for the ad 100 by the advertiser, and optionally include weightings for a variety of performance categories for the ad 100 by the advertiser. As used herein, “performance category” refers to the circumstances associated with the display of the ad, including, for example, the likelihood the ad 110 will be clicked or selected by a viewer, the reach of the ad 110, and the social context of the ad 110.

The historical statistics 120 associated with the ad 110 may be retrieved and used in determining the bid 105 for the ad 110. The historical stats 120 include the number of times the ad 110 has been selected and/or displayed, the bids associated with previous displays of the ad 110, the amount of budget previously used by the ad 110, the percentage of times the ad 110 has been clicked, or any other property associated with the ad 110. Optionally, the predicted ad performance 115 for the ad 110 is retrieved. The predicted ad performance 115 includes, for example, the predicted likelihood the ad 110 will be clicked by a viewer, the predicted likelihood the ad 110 will be interacted with by a viewer, the predicted type of interaction with the ad 110, or the availability of social context for the ad 110.

The bidding module 125 may determine a bid for the ad 110 based on the ad's constraints and goals, the historical stats 120, and the predicted ad performance 115. The bidding module 125 will be described in greater detail below. The auction module 130 receives the plurality of bids 105 and selects an ad as the selected ad 135. The auction module 130 may simply select the ad associated with the highest bid, or may select an ad based on other criteria as well, such as the context of the ad, the identity of the entity requesting the ad, or any other suitable criteria. This automated form of bidding precludes the need for advertisers to manually submit bids for ads, instead allowing an advertiser to merely set an ad's budget, plus other goals and constraints. Once ads and ad information are uploaded, bids are then determined without direct or explicit action by the advertisers.

### System Architecture

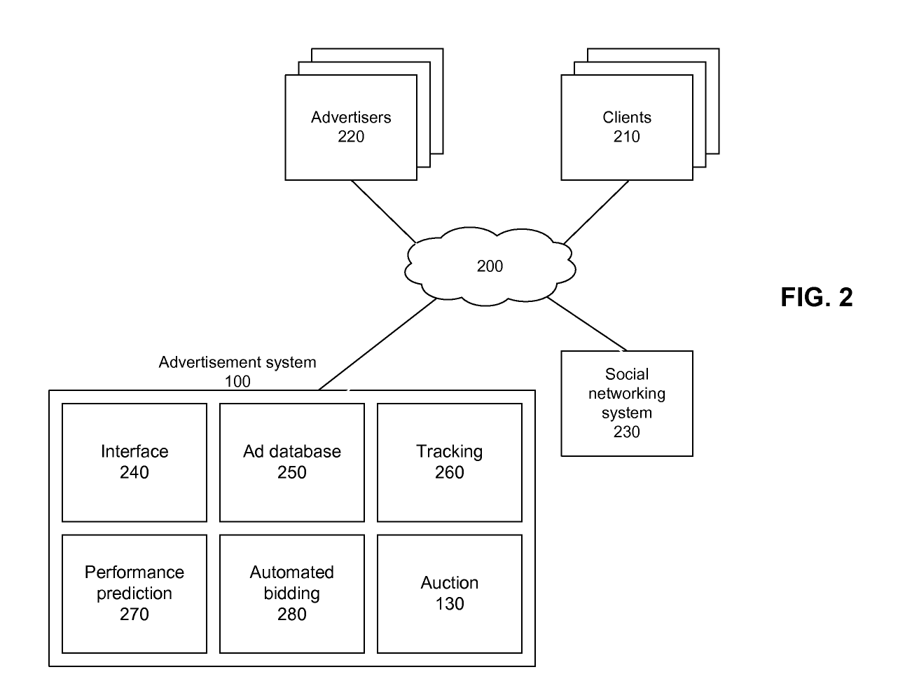

FIG. 2 is a high level block diagram of a system environment suitable for performing budget-based bidding or bidding based on multiple goals and constraints, according to one embodiment. The system environment includes clients 210, advertisers 220, social networking system 230 and the advertisement system 100 that communicate through a connecting networking 200. The advertisers 220 are configured to provide ads and ad information (such as ad budgets, other constraints, and goals) to the advertisement system 100. The clients 210 are configured to request an ad from the advertisement system 100, and the advertisement system 100 is configured to conduct an auction among stored ads and to select an ad based on the auction in response to receiving an ad request from a client 210. Although three clients 210 and three advertisers 220 are shown in FIG. 2, any number of clients 210 or advertisers 220 may communicate with the social networking system 230 and the advertisement system 100, for example thousands or millions. It should be noted that the advertisement system 100 may be implemented by one or more advertisers 220, or by the social networking system 230.

Clients 210 and advertisers 220 may communicate through the network 200 using client devices. Client devices may include any type of device capable of sending or receiving communications and other data to and from the social networking system 230 and the advertisement system 100, such as a mobile phone, a laptop, a netbook, a tablet, a desktop computer, or a television. As used herein, “client” refers to any entity which requests an ad from the advertisement system 100, and “advertiser” refers to an entity which provides an ad to the advertisement system 100 for subsequent display to a client. In one embodiment, the same entity may be both a client 210 and an advertiser 220, though clients 210 and advertisers 220 are described separately throughout the remainder of this description for the purposes of simplicity.

The connecting network may be the Internet, a local area network, a wireless network, a cellular network, or any other network that allows communication between modules. The connecting network 200 may use standard communications technologies and/or protocols. In alternative configurations, different and/or additional modules can be included in the system. In addition, the connecting network 200 may include a combination of networks. For example, in the embodiment where a client 210 is a mobile phone, the connecting network 200 may include a cellular phone wireless network which interfaces with the Internet, allowing the mobile phone to connect with, for example, a social networking system's web servers.

A client 210 may request an ad from the advertisement system 100 explicitly. For example, a client 210 may be a website accessed by a user of the website, and the website may request an ad from the advertisement system 100 to display on the website to the user. Alternatively, the client 210 may request an ad inexplicitly, by accessing or using a system which in turn requests an ad. For example, the client 210 may be the user of the website, and requesting an ad may include merely requesting access to the website. A client 210 may be a software application or a game, and the application or game may request an ad from the advertisement system 100 for display to a user of the application or game. For example, a user may play a game, and the game may request an ad from the advertisement system 100 to display in-game to the user. In one embodiment, the social networking system 230 is the client 210, and the social networking system 230 requests an ad from the advertisement system 100 to display to a user in a social networking system page.

The social networking system 230 may include a web-based interface comprising a series of inter-connected pages displaying and allowing users to interact with social networking system objects and other users. The social networking system pages may display information related to social networking system users, social networking system objects, communications between users, or any other information. The social networking system 230 allows users to establish connections within the social networking system (referred to herein as being “friends”). Social networking system data and actions taken by users in the social networking system 230 may be stored by the social networking system 230 for later retrieval.

Ads may include text, HTML-linked text, images, HTML-linked images, video, audio, Adobe Flash™, or any other digital-format. In one embodiment, ads are requested for display within pages, such as web pages, social networking system pages, and the like. An ad may be displayed in a dedicated portion of a page, such as in a banner area at the top of the page, in a column at the side of the page, in any portion of a page GUI, in a pop-up window, over the top of page content, or anywhere else in a page. Ads may be displayed within an application or within a game. Ads may be displayed in dedicated pages, requiring the user to interact with or watch the ad before the user may access a page, utilize an application, or play a game. A viewer may view the ad using a web browser on a computer, on a mobile device, on a television, and the like.

Ads may be interacted with in a variety of ways. A viewer of the ad may click on or otherwise select the ad, and the ad may direct the viewer to a page associated with the ad. Once on the page associated with the ad, the viewer may take additional actions, such as purchasing a product or service associated with the ad, receiving information associated with the ad, and subscribing to a newsletter associated with the ad. For audio and video ads, the ads may be played by selecting a component of the ad (like a “play button”). Ads may include games, which a viewer may play within the context of the ad. An ad may also allow a viewer to answer a poll or question posed within the ad.

Ads may contain social networking system functionality with which a viewer may interact. For instance, ads may allow a viewer to “like” or otherwise endorse the ad by selecting a button or link associated with endorsement. Likewise, a viewer may share the ad another social network system user, or may RSVP to an event associated with a social networking system event advertised in the ad. In addition, an ad may contain social networking system context directed to the viewer. For example, an ad may display information about a friend of the viewer within the social networking system who has taken an action associated with the subject matter of the ad.

Including social networking system functionality or context with an ad may occur in a number of ways. For example, the advertising system 100 may retrieve social functionality and context directly with the social networking system 230 and may combine the ad with the retrieved functionality or context prior to serving the ad to a viewer. Embodiments selecting and providing social networking system functionality and context with an ad are described in co-pending U.S. patent application Ser. No. 12/898,662, titled “Providing Social Endorsements with Online Advertising,” filed on Oct. 5, 2010 and U.S. patent application Ser. No. 13/043,424, titled “Selecting Social Endorsement Information for an Advertisement for Display to a Viewing User,” filed on Mar. 8, 2011, the contents of which are incorporated by reference herein in their entirety. Interacting with an ad containing social networking system functionality or context may cause information about the interaction to be displayed in the viewer's social networking system profile page.

As illustrated in FIG. 2, the advertisement system 100 includes an interface 240, an ad database 250, a tracking module 260, a performance prediction module 270, an automated bidding module 280, and the auction module 130 of FIG. 1. In other embodiments, the advertisement system 100 includes more or fewer components, and the components may perform differing functionality than described herein.

The interface 240 provides the communicative interface between the advertisement system 100 and the other modules of FIG. 2. The advertisement system 100 receives ads and associated ad information from the advertisers 220 via the interface 240, and stores the ads and ad information in the ad database 250. The advertisement system 100 also receives requests for ads from clients 210 via the interface 240, and, in response, selects ads to provide to the requesting clients 210 using an auction system as described herein. In one embodiment, the advertisement system 100 optionally retrieves social networking system information from the social networking system 230 via the interface 240 and stores this information in the ad database 250 or provides this information to one or more clients 210 requesting an ad in conjunction with a provided ad.

The tracking module 260 of the advertisement system 100 tracks statistics associated with ads stored by the advertisement system 100. The tracked statistics include, for example, the number of times an ad is provided to the client, the winning and losing bid amounts associated with an ad for each auction, the amount of budget used and the remaining budget for each ad, the number of total impressions for each ad, the number of impressions required for each ad to reach an impression goal set by the advertisers, performance information associated with the display of each ad, actions taken by viewers associated with each ad, and any other information associated with the ads, the display of the ads, and the goals and constraints set by the advertisers 220.

The performance prediction module 270 predicts or determines the performance of an ad displayed in response to an ad request. In one embodiment, the performance prediction module 270 determines the website, application, game, or other setting in which a requested ad will appear. The performance prediction module 270 may determine the content of the setting in a requested ad will appear. The performance prediction module 270 may also predict information related to the viewer of a requested ad, such as the viewer's age, location, education, job, or any other biographic information related to the viewer. The performance prediction module 270 may predict the diversity or scope of a viewing audience for a requested ad. For example, the performance prediction module 270 may predict that the viewer of a requested ad may live anywhere in the United States, may be of any socioeconomic background, or may have any educational background. Alternatively, the performance prediction module 270 may predict that the viewer of a requested ad lives in a very specific region of the United States, may be of a particular socioeconomic background, and may have a particular education.

The performance prediction module 270 may determine that a requested ad includes available social context. Likewise, the performance prediction module 270 may determine that a requested ad includes potential for social context dependent upon the identity of the viewer of the requested ad, and may predict the likelihood that the requested ad includes social context when displayed to the viewer.

The performance prediction module 270 may predict the likelihood that a viewer of a requested ad takes a particular action with regards to the requested ad. In one embodiment, the performance prediction module 270 predicts the likelihood that a viewer will click on or otherwise select a requested ad. In another embodiment, the performance prediction module 270 predicts the likelihood that a viewer will share, “like” or otherwise endorse the ad within the context of a social networking system. The performance prediction module 270 may predict the likelihood that a viewer will watch a requested ad, play a requested ad, answer a question or survey posed in a requested ad, make a purchase in conjunction with the requested ad, or any other action which a viewer may take with regards to a requested ad.

The automated bidding module 280 is configured to produce bids for one or more ads stored in the ad database 250 in response to receiving a request for an ad from a client 210. In one embodiment, the automated bidding module 280 produces a bid for each ad stored in the ad database 250. Alternatively, the automated bidding module 280 may produce a bid for each ad stored in the ad database 250 with unused budget, or for each ad that has not reach the ad's impression goal. As discussed below, the automated bidding module 280 may determine bids based on the ad request, ad content, ad budgets or other ad constraints, ad impression goals, ad performance weightings, social networking system ad functionality or ad context, the statistics associated with ads received from the tracking module 260, the predicted ad performance received from the performance prediction module 270, or any other factor associated with the ad, the requesting client 210 or the requesting ad viewer.

### Advertisement Database

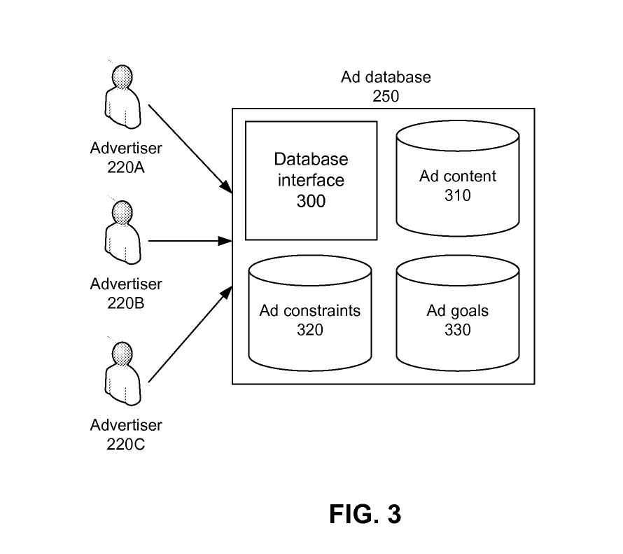

FIG. 3 is a block diagram illustrating an ad database configured to receive ads, ad constraints and ad context goals from one or more advertisers, according to one embodiment. Although only three advertisers 220 are illustrated in FIG. 3, it should be noted that any number of advertisers may upload ads to the ad database 250. The ad database 250 includes a database interface 300, an ad content storage module 310, an ad constraints storage module 320, and an ad goals storage module 330. In other embodiments, the ad database 250 may include more or fewer components, and the storage modules 310, 320, and 330 may be combined into a single storage module.

The database interface 300 provides the communicative interface between the advertisers 220 and the ad database 250. In one embodiment, the database interface 300 is the interface 240. The database interface 300 receives ads, ad constraints and ad goals from the advertisers 220 and stores them in the ad content storage module 310, the ad constraints storage module 320 and the ad goals storage module 330, respectively.

The database interface 300 may include a user interface (UI) which advertisers may use in uploading ads, and setting ad constraints and ad goals. The UI may include ad templates, which allow advertisers 220 to create ads or modify the content of existing ads. For example, an advertiser 220 may use the UI to modify an ad designed for a computer web browser to optimize the ad for display on a mobile phone. The UI may also include sliders or other interface tools to allow advertisers 220 to set an ad's budget or impression goals, to associate the ad with a particular campaign, to weight the ad's performance weightings, to suggest ad goals based on the content of the ad, and the like.

The ad content storage module 310 stores the ads uploaded by the advertisers 220. The ad content storage module 310 may store the ads in the format uploaded by the advertisers 220, or may alter the format as needed. The ad content storage module 310 may also store meta data associated with the ads, such as the subject matter of the ads, companies or products associated with the ads, and information describing the relatedness between ads (for example, the ads associated with a particular ad campaign).

The ad content storage module 310 may include associated social networking system functionality or context received from the social networking system 230. For example, if an social context was retrieved for an ad stored in the ad content storage module 310, the social context may be stored in the ad content storage module 310 in association with the ad for future retrieval. The ad content storage module 310 may include historical statistics associated with stored ads. For example, the ad content storage module 310 may store the number of times

The ad constraints storage module 320 stores constraints associated with stored ads. In one embodiment, each ad stored in the ad content storage module 310 is associated with a set of ad constraints stored in the ad constraints storage module 320. Ad constraints include ad budgets. Advertisers may set a budget for each individual ad, for example $10,000. Alternatively, advertisers may set a budget for an ad campaign, and each ad associated with the campaign is subject to the campaign budget. The ad constraints storage module 320 may also store the remaining budget associated with each ad. For example, each time an ad is selected and displayed to a viewer, the cost of displaying the ad may be subtracted from the ad's budget, and the remaining budget balance may be stored in the ad constraints storage module 320. In addition, the ad constraints storage module 320 may store the costs associated with each display of an ad. This beneficially allows advertisers 220 to track the costs of each ad display.

The ad constraints storage module 320 may also store a time period associated with each ad. Advertisers 220 when uploading ads to the ad database 250 may indicate the time period an uploaded ad is to run (the time period the ad is eligible for display). For example, an advertiser may indicate that a particular ad may be displayed during a first time period, or may indicate that ads for a particular ad campaign may be displayed during a second time period.

The ad goals storage module 330 stores goals associated with stored ads. In one embodiment, each ad stored in the ad content storage module 310 is associated with a set of ad goals stored in the ad goals storage module 330. Ad goals include target ad impression goals. An advertiser 220 sets the ad impression goals for each uploaded to the ad database 250. The ad impression goal associated with an ad is the number of impressions the advertiser 220 wants the ad to obtain. An advertiser 220 may also set a single ad impression goal for all of the ads associated with an ad campaign.

Ad goals may also include performance weightings for a variety of ad performance categories. An advertiser 220 may set the performance weightings for an ad to indicate the desired performance for the ad. Performance categories include the likelihood that an ad will be clicked (“clicks”), the reach of the ad (the diversity, size, and scope of the viewing audience) (“reach”), the presence of social networking system functionality or context within the ad (“social”), the likelihood of interactions with the ad (“interaction”), or any other factor associated with the display of the ad or the ad's audience.

Performance weightings are received from an advertiser 220. In one embodiment, the weights associated with each performance weighting are coefficients on the interval [0.0, 1.0]. The sum of the performance weightings associated with an ad may be 1.0, or may be any other number. For example, an advertiser 220 may set the weightings for an ad at 0.6 clicks, 0.2 reach, 0.1 social, and 0.1 interaction. Alternatively, an advertiser 220 may set the weightings for an ad at 0.0clicks, 0.0 reach, 1.0 social and 1.0 interaction. An advertiser 220 may provide variable sets of weightings based on the amount of time remaining in a set time period for the display of an ad, an amount of budget remaining for the ad, or any other factor. In one embodiment, the ad database 250 recommends weightings for an advertiser 220 based on an ad's content, goals, constraints, or any other factor.

### Advertisement Bidding

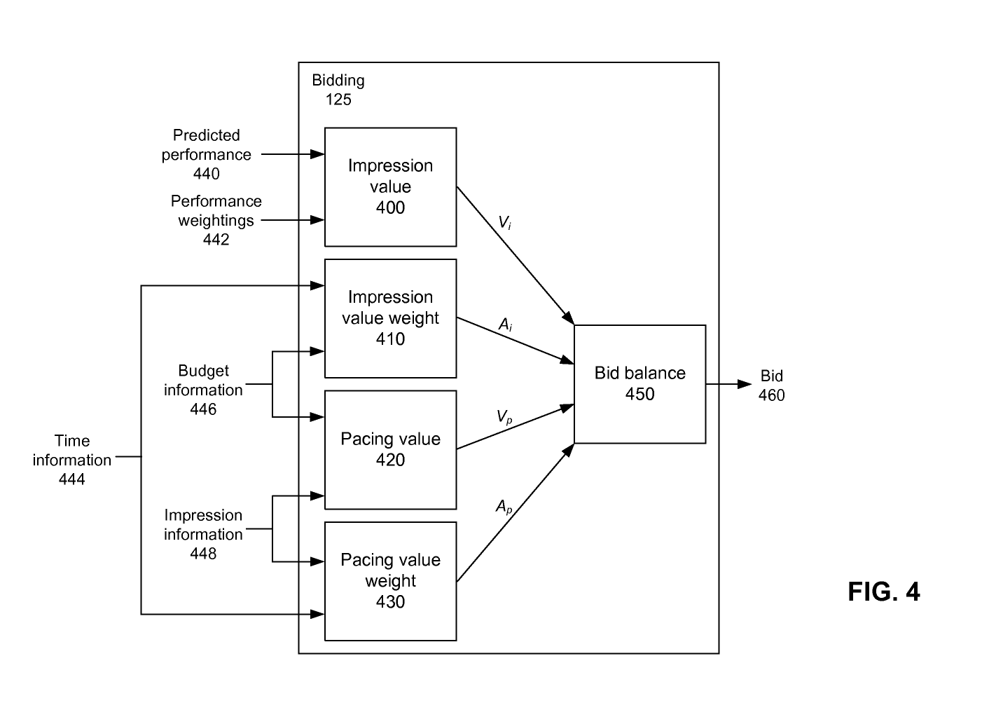

FIG. 4 is a block diagram illustrating a bidding module configured to receive information related to the ad and to produce a bid for the ad, according to one embodiment. As illustrated in FIG. 4, the bidding module 125 includes an impression value module 400, an impression value weight module 410, a pacing value module 420, a pacing value weight module 430, and a bid balance module 450. In various other embodiments, fewer or additional modules are included in the bidding module 125, and the functionalities of the modules in the bidding module 125 may be combined and/or different than described herein.

The impression value module 400 determines the potential value of an impression of an ad (“Vᵢ”) to the advertiser 220 associated with the ad, and provides Vᵢ to the bid balance module 450. For example, the impression value module 400 may determine that a particular impression for a particular ad is worth $1.50 to the advertiser that uploaded the ad. The impression value module 400 may determine Vᵢ based on any suitable criteria. For example, Vᵢ may be based on the setting of the impression, the historical value of the impression, the time or date of the impression, the identity of the entity requesting an ad, or any other suitable criteria.

The impression value module 400 may determine Vᵢ based on the predicted performance 440 of the impression. The predicted performance 440 is received from, for example, the performance prediction module 270. In one embodiment, the predicted performance categories include clicks (the predicted likelihood the ad will be selected), reach (the predicted reach of the ad), social (the presence of social functionality or context in the ad), and/or interaction (the predicted likelihood of particular interactions with the ad). Vᵢ may be determined based on a pre-determined weighting of predicted performance categories. Alternatively, the predicted performance categories may be weighted based on the setting of the impression, the identity of the requesting entity, or any other suitable criteria. In one embodiment, the predicted performance categories include probabilities on the interval [0.0, 1.0]. For example, if the impression value module 400 determines that a viewer is 45% likely to click on an ad, the clicks predicted performance category is 0.45. Certain predicted performance categories, for example social, may include either a 0 value or a 1 value depending on whether or not an ad or impression contains social functionality or context.

The impression value module 400 may determine the potential value of an impression of an ad based on a combination of the predicted performance 440 and performance weightings 442 received from advertisers 220 for ads stored in the ad database 250. As discussed above, an advertiser 220 may weight ad performance categories based on the importance of the categories to the advertiser 220 for the ad, the demographic group targeted by the advertiser 220 for the ad, the advertising strategy of the advertiser 220 for the ad, or based on any other suitable factor. For example, an advertiser 220 may assign the clicks, reach, social, and interaction performance weightings “0.4”, “0.1”, “0.25”, and “0.25”, respectively.

In one embodiment, the impression value module 400 determines Vᵢ by summing the products of each performance weighting and the associated predicted performance value for a particular performance category, for each performance category for which an advertiser 220 provides a weighting, and multiplying the sum by the value of an ad to the advertiser 220. The value of an ad to an advertiser 220 may be the value of the ad in an optimal context (a context where each predicted performance category associated with a non-zero weighting is 1.0). Alternatively, the sum is multiplied by a different ad valuation, such as a valuation provided by an advertiser 220, a pre-determined valuation, a valuation based on the identity of the requesting entity, or any other fact. Consider an example using the 0.4 clicks/0.1 reach/0.25 social/0.25 interactions weighting example above, and using the predicted performance values 0.7 clicks (representing a 70% chance the impression will be selected)/0.3 reach (representing some measure of audience reach determined by the context prediction module 270)/0 social (representing no social functionality or context in the impression)/0.6 (representing a 60% likelihood of a particular action being taken). In this example, the sum of the products of the performance weightings and the associated predicted performance values is 0.4*0.7+0.1*0.3+0.25*0+0.25*0.6=0.46. This is multiplied by the value of the ad in an optimal context, which may be provided by the advertiser 220 or may be determined independently. Assuming the value of the ad in this example in an optimal context is $2.00, Vᵢ is determined to be $2.00*0.46, or $0.92.

Vᵢ may be optionally weighted based on time information 444 for the ad and budget information 446 for the ad. The impression value weight module 410 receives the time information 444 and budget information 446 from the ad database 250 and the tracking module 260, and provides an impression value weight Aᵢ to the bid balance module 450. The time information 444 may include the total time period for which an ad is to run, the remaining amount of time in the time period for the ad to run, the remaining proportion of time in the time period for the ad to run, or any other factor related to the time period of an ad. The budget information 446 may include the total budget for an ad, the remaining amount of budget for the ad, the remaining proportion of budget for the ad, or any other factor related to ad budget.

The impression value weight module 410 may determine Aᵢ based on the remaining proportion of budget left for an ad and the remaining proportion of time left for an ad. In one embodiment, the impression value weight module 410 determines Aᵢ to be the ratio of the remaining proportion of budget to the remaining proportion of time for an ad. For example, if 50% of the budget for an ad remains and 50% of the time period for an ad remains, Aᵢ is determined to be 1. Likewise, if 80% of the budget for an ad remains, and 20% of the time period for an ad remains, Aᵢ is determined to be 4, and if 30% of the budget for an ad remains and 75% of the time period for an ad remains, Aᵢ is determined to be 0.4. The impression value weight module 410 may limit the interval in which Aᵢ may be determined, for instance to the interval [0.0, 2.0]. It should be noted that the impression value weight module 410 may determine Aᵢ in ways other than those discussed herein.

The pacing value module 420 determines the potential value to an advertiser 220 of displaying an ad based on the pace of the impressions of the ad, and provides this value to the bid balance module 450. The pacing value, Vₚ, is based on the budget information 446 and the impression information 448 received by the pacing value module 420 from the ad database 250 and the tracking module 260. The impression information 448 may include the impression goal set by an advertiser 220, the total number of impressions of the ad, the total number of remaining impressions of the ad until the impression goal is met, the proportion of remaining impressions until the impression goal is met, or any other factor related to ad impressions.

In one embodiment, the budget information 446 includes the amount of budget remaining for the ad, and the impression information 448 includes the amount of impressions remaining for the ad (for example, the impressions goal minus the total impressions so far for the ad). The pacing value module 420 may determine Vₚ to be the ratio of the remaining budget to the remaining impressions. For example, if the unspent budget for an ad is $10,000, and if the number of impressions remaining to reach the ad's impression goal is 20,000, the pacing value module 420 may determine Vₚ to be $0.50.

Vₚ may be optionally weighted based on time information 444 for the ad and impression information 448 for the ad. The pacing value weight module 430 receives the time information 444 and impression information 448 from the ad database 250 and the tracking module 260, and provides a pacing value weight Aₚ to the bid balance module 450. The pacing value weight module 430 may determine Aₚ based the remaining proportion of impressions left for an ad and the remaining proportion of time left for an ad. In one embodiment, the pacing value weight module 430 determines Aₚ to be the ratio of the remaining proportion of impressions to the remaining proportion of time for an ad. For example, if 75% of the impressions goal for an ad remains and 25% of the time period for an ad remains, Aₚ is determined to be 3. Likewise, if 10% of the impressions goal for an ad remains, and 90% of the time period for an ad remains, Aₚ is determined to be 0.111. Similarly to the impression value weight module 410, the pacing value weight module 430 may limit Aₚ to a particular interval. It should be noted that the pacing value weight module 430 may determine Aₚ in ways other than those discussed herein.

The bid balance module 450 determines a bid 460 for the ad, and outputs the bid 460 to the auction module 130. The bid balance module 450 may receive any of the impression value Vᵢ, the impression value weight Aᵢ, the pacing value Vₚ, and the pacing value weight Aₚ, and may use these values to determine the bid 460. In one embodiment, the bid balance module 460 determines the value of the bid 460 to be the sum Vᵢ*Aᵢ+Vₚ*Aₚ. Alternatively, the bid balance module 460 may determine the value of the bid 460 based only on Vᵢ and Aᵢ. In one embodiment, an advertiser 220 may not provide an impression goal for an ad, and the bid 460 is determined to be Vᵢ*Aᵢ. Any other method of determining a bid 460 based on the information received by or the factors computed by the bidding module 125.

In the embodiments described above, Aᵢ and Aₚ are determined independently of each other. In an alternative embodiment, Aᵢ and Aₚ are determined together. For example, Aᵢ and Aₚ may be determined such that Aᵢ*Aₚ=k, where k is any non-zero constant, such as 1.0. Alternatively, Aᵢ and Aₚ may be determined such that Aᵢ+Aₚ=k. Computing Aᵢ and Aₚ together beneficially helps balance an ad's budget and impressions goal. For example, if rate of consuming an ad's budget exceeds the rate of progressing towards the ad's impressions goal, then the value Aᵢ may be lowered while the value Aₚ is raised. The converse is also true—if Aᵢ is raise, then Aₚ may be lowered in response.

### Operation

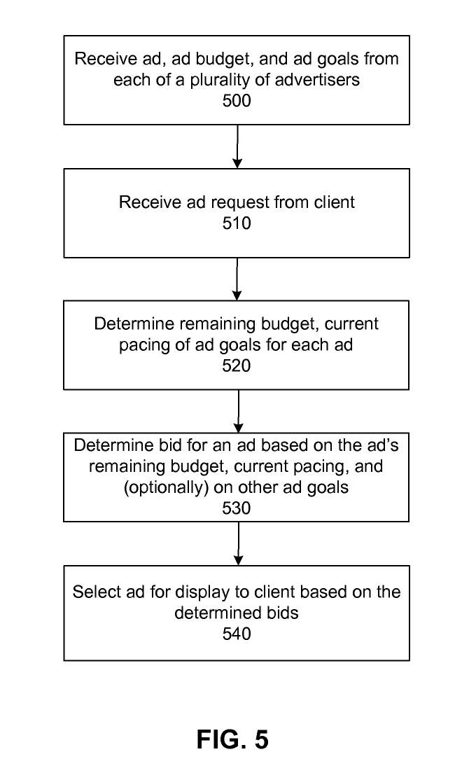

FIG. 5 is a flowchart illustrating a process for selecting an ad for display based on the ad's budget and goals, according to one embodiment. An ad and an associated ad budget and ad goals are received 500 from a plurality of advertisers. The ads, ad budgets, and ad goals may be stored in an ad database. In one embodiment, the ads, ad budgets, and ad goals are received and stored ahead of time for subsequent retrieval by the method of FIG. 5. Ad goals include a target number of impressions for the ad, for instance over a particular time period for which the ad may be displayed.

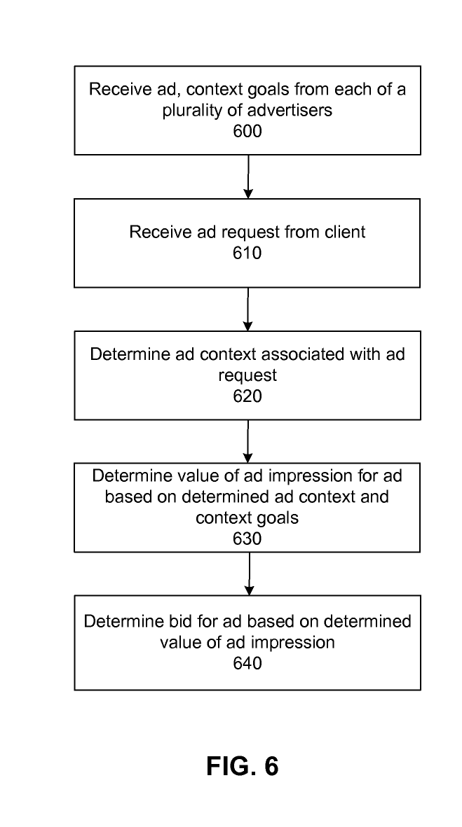

An ad request is received 510 from a client. In response to receiving the ad request, the remaining ad budget and the pacing of the ad goals are determined 520 for each of a plurality of ads. For example, a particular ad may have $5000 of remaining budget and may have reached 60% of the ad's impression goal; this information is determined for each of a set of ads for which bids are to be determined. A bid is determined 530 for each of the plurality of ads based on the determined remaining budget and impression goal pacing for the ad. The bids may additionally be determined based on other ad goals, as discussed in the method of FIG. 6. An ad is then selected 540 based on the determined bids. For example, a traditional auction may be implemented to select the highest determined bid, and the ad associated with the highest bid is selected for display to the requesting client.

FIG. 6 is a flowchart illustrating a process for selecting an ad for display based on ad performance weightings, according to one embodiment. An ad and associated ad performance weightings are received 600 from one or more advertisers. Performance weightings include weightings for performance categories, such as the likelihood that the ad will be selected, the reach of the ad, the presence of social networking system functionality or context in the ad, and the likelihood that a viewer will interact with the ad in a particular way. Performance weightings may be provided by the advertisers in the form of values for performance categories, indicating the importance of each category to the advertiser for the ad. The ads and performance weightings may be received and stored ahead of time for subsequent retrieval by the method of FIG. 6.

An ad request is received 610 from a client. In response to receiving the ad request, the predicted performance associated with the ad request is determined 620. In one embodiment, determining the predicted performance for an ad request includes predicting values for various performance categories, such as the likelihood that the ad will be selected. The value of the ad impression associated with the ad request for an ad is determined 630 based on the predicted ad performance and the performance weightings associated with the ad. In one embodiment, the values representing predicted ad performance categories are multiplied by associated values representing performance weightings for each category, and the resulting products are summed to determine the value of the ad impression. A bid is then determined 640 for the ad based on the determined value of the ad impression associated with the ad request for the ad.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving from an advertiser for each of a plurality of ads:
a budget for the ad, and
an impressions goal for the ad;
receiving a request for an ad from a client;
for each of the plurality of ads, determining a bid for the ad, wherein determining a bid for the ad comprises:
determining a remaining budget for the ad based on the received budget for the ad and a current amount of used budget for the ad,
determining a remaining impressions goal for the ad based on the received impressions goal for the ad and a current amount of impressions for the ad, and
determining a bid for the ad based on the determined remaining budget for the ad and the determined remaining impressions goal for the ad; and
selecting an ad for display to the client from the plurality of ads based on the determined bids for the plurality of ads.

2. A method comprising:
receiving a request for an ad from a client;
determining a bid for each of a plurality of ads, wherein determining a bid for an ad comprises:
determining a budget associated with the ad;
determining an impressions goal associated with the ad; and
determining a bid for the ad based on the determined budget and the determined impressions goal; and
selecting an ad for display to the client from the plurality of ads based on the determined bids for the plurality of ads.

3. The method of claim 2, wherein receiving a request for an ad from a client comprises receiving a request for an ad at a web server in response to the client requesting a web page.

4. The method of claim 2, wherein receiving a request for an ad from a client comprises receiving a request for an ad from an application in response to an interaction with the application with a user of the application.

5. The method of claim 2, further comprising:
receiving, for each of the plurality of ads, a budget associated with the ad, and an impressions goal associated with the ad; and
storing the budgets and impressions goals in connection with the associated ads.

6. The method of claim 2, further comprising tracking the historical statistics of each of the plurality of ads by storing the bid amount of the selected ad, the historical statistics of each ad comprising at least the total amount spent on displaying the ad and the number of impressions for the ad.

7. The method of claim 6, wherein determining a budget associated with an ad comprises:
determining a total budget for the ad set by an advertiser;
determining the amount of the total budget for the ad that has been used to display the ad prior to receiving the request for the ad; and
determining the remaining budget for the ad by subtracting the amount of the total budget that has been used from the total budget.

8. The method of claim 6, wherein determining an impressions goal associated with an ad comprises:
determining a total impressions goal for the ad set by an advertiser;
determining the number of impressions for the ad prior to receiving the request for the ad; and
determining the number of impressions for the ad required to reach the total impressions goal by subtracting the determined number of impressions for the ad from the total impressions goal.

9. The method of claim 2, wherein determining a bid for the ad based on the determined budget and the determined impressions goal comprises:
determining an impression value for the ad, wherein the impression value for the ad comprises the potential value of an impression of the ad at the requesting client to an advertiser associated with the ad;
determining a pacing value for the ad, wherein the pacing value for the ad comprises the value of displaying the based on the pace of the impressions of the ad; and
combining the determined impression value for the ad with the determined pacing value for the ad to determine a bid for the ad.

10. The method of claim 9, wherein determining a bid for the ad further comprises:
determining an impression value weight based on a remaining proportion of budget for the ad and a remaining proportion of time for the ad for which the ad is eligible to be display, relative to a total ad display time period set by the advertiser associated with the ad;
weighting the determined impression value for the ad with the determined impression value weight; and
combining the weighted impression value for the ad with the determined pacing value for the ad to determine a bid for the ad.

11. The method of claim 10, wherein the determined impression value weight comprises the ratio of the remaining proportion of budget for the ad to the remaining proportion of time for the ad.

12. The method of claim 10, wherein determining a bid for the ad further comprises:
determining a pacing value weight based on a remaining proportion of impressions required to reach the ad's impressions goal relative to the impressions goal and the remaining proportion of time for the ad;
weighting the determined pacing value for the ad with the determined pacing value weight; and
combining the weighted impression value for the ad with the weighted pacing value for the ad to determine a bid for the ad.

13. The method of claim 12, wherein the determined pacing value weight comprises the ratio of the remaining proportion of impressions for the ad to the remaining proportion of time for the ad.

14. The method of claim 12, wherein combining the weighted impression value for the ad with the weighted pacing value for the ad comprises adding the weighted impression value for the ad with the weighted pacing value for the ad.

15. The method of claim 12, wherein the impression value weight and the pacing value weight are determined together, such that the impression value weight and the pacing value weight are inversely proportional.

16. The method of claim 12, wherein selecting an ad for display comprises selecting the ad associated with a highest determined bid.

17. A method comprising:
receiving a request for an ad from a client;
determining a bid for each of a plurality of ads, wherein determining a bid for an ad comprises:
determining a budget associated with the ad,
determining an impression value for the ad, wherein the impression value for the ad comprises the potential value of an impression of the ad at the requesting client to an advertiser associated with the ad, and
determining a bid for the ad based on the determined budget and the determined impression value; and
selecting an ad for display to the client from the plurality of ads based on the determined bids for the plurality of ads.

18. The method of claim 17, further comprising:
receiving, from each of a plurality of advertisers:
an ad; and
a budget associated with the ad; and
storing the received ads and the associated budgets.

19. The method of claim 17, wherein determining a budget associated with an ad comprises:
determining a total budget for the ad set by the advertiser associated with the ad;
determining the amount of the total budget for the ad which has been used to display the ad prior to receiving the request for the ad; and
determining the remaining budget for the ad by subtracting the amount of the total budget which has been used from the total budget.

20. The method of claim 17, wherein determining a bid for the ad further comprises:
determining an impression value weight based on a remaining proportion of budget for the ad and a remaining proportion of time for the ad for which the ad is eligible to be display, relative to a total ad display time period set by the advertiser associated with the ad;
weighting the determined impression value for the ad with the determined impression value weight; and
determining a bid for the ad based on the weighted determined impression value for the ad.
